(19) United States
(12) Patent Application Publication
(10) Pub. No.: US 2009/0058582 A1
(43) Pub. Date: Mar. 5, 2009

(54) SYSTEMS AND METHODS FOR EXTRACTING NET-POSITIVE WORK FROM MAGNETIC FORCES

(76) Inventor: Thomas A. Webb, Bellevue, WA (US)

Correspondence Address: Ruttler Law PLLC;One Union Square, 600 University Street, Suite 1919, Seattle, WA, 98101, US

(21) Appl. No.: 11/849,581

(22) Filed: Sep. 4, 2007

(51) Int. Cl. H01F 7/02; H01F 7/08

(52) U.S. Cl. 335/229; 335/306

(57) ABSTRACT

This invention relates generally to magnets, and more specifically, to improved systems and methods for extracting net-positive work from magnetic forces. In one embodiment, the invention includes the steps of magnetically coupling a first stack magnet to a gate magnet; permitting at least one wheel magnet to approach the first stack magnet and the gate magnet, the first stack magnet and the gate magnet exerting magnetic attractive force upon the at least one wheel magnet; facilitating separation of the gate magnet and the first stack magnet using magnetic force from at least one additional magnet; facilitating movement of the gate magnet and the at least one wheel magnet towards a second stack magnet; facilitating magnetic coupling of the gate magnet to the second stack magnet; permitting the at least one wheel magnet to distance itself from the gate magnet and the second stack magnet, the gate magnet and the second stack magnet exerting magnetic repulsive force upon the at least one wheel magnet; facilitating separation of the gate magnet and the second stack magnet using magnetic force from the at least one additional magnet; facilitating movement of the gate magnet towards the first stack magnet; and facilitating magnetic coupling of the gate magnet to the first stack magnet.

### FIELD OF THE INVENTION

This invention relates generally to magnets, and more specifically, to improved systems and methods for extracting net-positive work from magnetic forces.

### BACKGROUND

A magnet produces a magnetic field through the movement of electrons. Accordingly, a magnetic field is produced by an electromagnet when current is driven through a wire and by a permanent magnet through the intrinsic orbital and angular momentum of electrons within atoms. Each magnetic field includes an apparent positive and negative pole, which result from an accumulation of independent dipoles that are microscopically close to one another and inseparable. The strength of the magnetic field generally depends upon the distance from the magnet, the relative magnetic latitude, the dipole moment, and the permeability of the surrounding medium. When two magnetic fields are in proximity to one another, opposite poles result in an attractive force while similar poles result in a repulsive force. The strength of the magnetic force generally depends upon the magnetic field strengths, the permeability of the intervening medium, and the distance of separation.

The attractive and repulsive magnetic force properties of magnets have been exploited in a wide variety of applications. For instance, traditional speakers depend upon the interaction of an electromagnet and a permanent magnet to move air and thereby produce sound. Transformers work by transferring electric energy between two coils that are isolated electrically, but linked magnetically. Coupling chucks within the metalworking industry secure metal using a controllable electromagnet. Traditional magnetic recording media such as VHS tapes, audio cassettes, and computer disks encode information thereon using thin magnetic coatings. Similarly, modern credit, debit, and gift cards each use thin magnetic surface strips to store important financial information therein. Furthermore, common electric motors and generators often rely on the interaction between permanent and electromagnets to convert electric energy into mechanical energy or mechanical energy into electrical energy, respectively.

In addition to this wide array of uses, effort has also been made to harness the repulsive and attractive magnetic forces that result from the interaction of two magnetic fields in order to perform work. As stated supra, an attractive magnetic force results when opposing poles of a magnetic field are in proximity with one another and a repulsive magnetic force results when similar poles are in proximity with one another. This phenomenon is easily demonstrated by the fact that when two magnets are initially separated the attractive magnetic force will bring them together and the repulsive magnetic force will drive them apart. Quite clearly, the movement over a distance by the two magnets that occurs as a result of the attractive and repulsive magnetic forces can be used to perform work. However, because the same amount of force is required to oppose any attractive or repulsive magnetic forces and return the two magnets to their original positions, the net amount of work performed by the interaction of magnetic fields is zero.

The TOMI (Theory of Magnetic Instability) reference, cited on the information disclosure statement filed herewith, attempts to address the problem of net zero work using the force of gravity to reduce the amount of force that must be supplied to oppose magnetic forces. In TOMI, two oppositely disposed magnets are aligned in parallel at a slight upward angle to define a channel therein for receiving a third magnet. The third magnet is initially repelled from one end of the channel towards the other end where it is attracted. Before reaching the other end of the channel, however, the third magnet falls under the force of gravity to within a second channel defined by fourth and fifth magnets. Although this process is repeatable to perform work using the third magnet, it suffers from many problems. Most notably, it requires the cumbersome use of a series of magnets in an elongated track setup. Furthermore, the speed of the work output is limited by the acceleration of gravity.

Thus, although desirable results have been achieved, there exists much room for improvement. What are needed therefore are improved systems and methods for extracting net-positive work from magnetic forces.

### SUMMARY

This invention relates generally to magnets, and more specifically, to improved systems and methods for extracting net-positive work from magnetic forces. In one embodiment, the invention includes the steps of magnetically coupling a first stack magnet to a gate magnet; permitting at least one wheel magnet to approach the first stack magnet and the gate magnet, the first stack magnet and the gate magnet exerting magnetic attractive force upon the at least one wheel magnet; facilitating separation of the gate magnet and the first stack magnet using magnetic force from at least one additional magnet; facilitating movement of the gate magnet and the at least one wheel magnet towards a second stack magnet; facilitating magnetic coupling of the gate magnet to the second stack magnet; permitting the at least one wheel magnet to distance itself from the gate magnet and the second stack magnet, the gate magnet and the second stack magnet exerting magnetic repulsive force upon the at least one wheel magnet; facilitating separation of the gate magnet and the second stack magnet using magnetic force from the at least one additional magnet; facilitating movement of the gate magnet towards the first stack magnet; and facilitating magnetic coupling of the gate magnet to the first stack magnet.

### BRIEF DESCRIPTION OF THE DRAWINGS

Embodiments of the present invention are described in detail below with reference to the following drawings:

FIG. 1 is a perspective view of a wheel and gate system for extracting net-positive work from magnetic forces, in accordance with an embodiment of the invention;

FIG. 2 is a top plan view of a gate system for extracting net-positive work from magnetic forces, in accordance with an embodiment of the invention;

FIG. 3 is an enlarged side elevational view of a wheel and gate system in a first position for extracting net-positive work from magnetic forces, in accordance with an embodiment of the invention;

FIG. 4 is an enlarged side elevational view of a wheel and gate system in a second position for extracting net-positive work from magnetic forces, in accordance with an embodiment of the invention;

FIG. 5 is an enlarged side elevational view of a wheel and gate system in a third position for extracting net-positive work from magnetic forces, in accordance with an embodiment of the invention;

FIG. 6 is an enlarged side elevational view of a wheel, gate, and pendulum system for extracting net-positive work from magnetic forces, in accordance with an embodiment of the invention;

FIG. 7 is a top plan view of an alternative gate system for extracting net-positive work from magnetic forces, in accordance with an embodiment of the invention; and

FIG. 8 is a top plan view of an alternative electromagnet gate system for extracting net-positive work from magnetic forces, in accordance with an embodiment of the invention.

### DETAILED DESCRIPTION

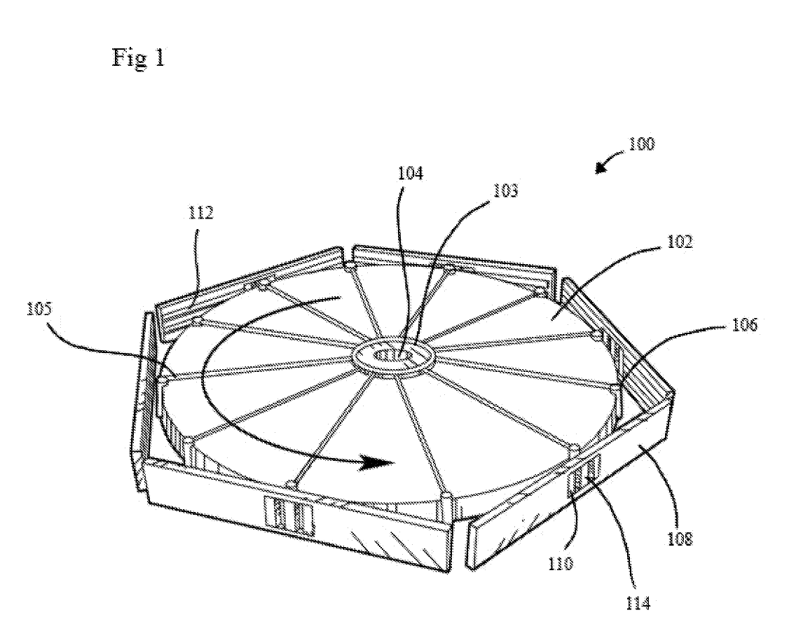

This invention relates generally to magnets, and more specifically, to improved systems and methods for extracting net-positive work from magnetic forces. Specific details of certain embodiments of the invention are set forth in the following description and in FIGS. 1-8 to provide a thorough understanding of such embodiments. The present invention may have additional embodiments, may be practiced without one or more of the details described for any particular described embodiment, or may have any detail described for one particular embodiment practiced with any other detail described for another embodiment.

FIG. 1 is a perspective view of a wheel and gate system for extracting net-positive work from magnetic forces, in accordance with an embodiment of the invention. In one embodiment, system 100 includes a wheel 102, at least one wheel magnet 106, and at least one frame 108. The wheel 102 includes at least one radial arm 105 and a hub 103 defining an axle cavity 104. The at least one frame 108 includes stack magnets 112 and a gate 110 having gate magnets 114.

The wheel 102 is cylindrically shaped with the at least one radial arm 105 extending from the hub 103 centrally to its perimeter to contribute to structural integrity of the wheel 102. The axle cavity 104 of the hub 103 is configurable to receive a shaft (not illustrated for clarity). The shaft is usable to perform mechanical work or generate electricity upon rotation of the wheel 102. In certain embodiments, the wheel 102, the hub 103, the at least one radial arm 105, or the shaft can be constructed from any material or combination of material including metal, wood, plastic, or synthetic composition. Further, the wheel 102, the hub 103, the at least one radial arm 105, or the shaft can be any one, two, or three dimensional shape, can be omitted in whole or part, can be supplemented by various components, or can be constructed from fewer or greater components. For example, the wheel 102 can include a plurality of the at least one radial arm 105 for providing additional structural integrity. Alternatively, the at least one radial arm 105 can be omitted from the wheel 102. Further, the wheel 102 can be in the form of a hexagon, octagon, sphere, or some other uniform or non-uniform shape. Additionally, the wheel 102 can be omitted in favor of a spoke system including only the hub 103 and the at least one radial arm 105.

The at least one wheel magnet 106 is disposed on the wheel 102 perimeter proximate to the distal end of the at least one radial arm 105. The at least one wheel magnet 106 is comprised of a series of smaller cylindrical magnets stacked upon one another and extends at least a portion of the distance between a top and bottom of the wheel 102 cylindrical surfaces. The wheel 102 can include a plurality of the at least one wheel magnet 106 similarly disposed about its perimeter. In certain embodiments, the at least one wheel magnet 106 is a permanent magnet, an electromagnet, a combination of magnets, a single magnet, or some other magnet. Further, the at least one wheel magnet 106 can define any one, two, or three-dimensional shape. Also, the at least one wheel magnet 106 can be alternatively disposed on, proximate to, or within the wheel 102 or the at least one radial arm 105.

The at least one frame 108 is a generally planar elongated structure that supports and encapsulates the gate 110 approximately midway along its length. The gate 110 defines a space for receiving the gate magnets 110 therein, which are configurable to slidably transition between opposing ends of the gate 110 within a common plane of the at least one frame 108. The stacked magnets 112 are disposed along a length of the at least one frame 108, but are interrupted by the gate 110. Accordingly, the gate magnets 114 are configurable to removably couple to the stacked magnets 112 on one end of the gate 110 and slidably transition within a common plane of the at least one frame 108 to removably couple to the stacked magnets 112 on the other end of the gate 110. The at least one frame 108 is disposed proximate to the wheel 102 perimeter such that the at least one wheel magnet 106 is configurable to magnetically interact with the stacked magnets 112 and the gate magnets 114. The wheel 102 can include a plurality of the at least one frame 108 similarly disposed proximate to its perimeter. In various embodiments, the at least one frame 108 or the gate 110 are constructed from any material or combination of material including metal, wood, plastic, or synthetic composition. The gate magnets 114 or the stacked magnets 112 can be permanent magnets, electromagnets, a combination of permanent magnets and electromagnets, or some other magnet. Further, the at least one frame 108, the gate 110, the gate magnets 114, or the stacked magnets 112 can be any one, two, or three dimensional shape, can be omitted in whole or part, can be alternatively disposed relative to the wheel 102, can include additional components, or can be constructed from fewer or greater components. For instance, the at least one frame 108, the gate 110, the gate magnets 114, or the stacked magnets 112 can be curvilinear to approximately mirror the wheel 102 curvature. Further, additional gates 110 can be disposed on the at least one frame 108.

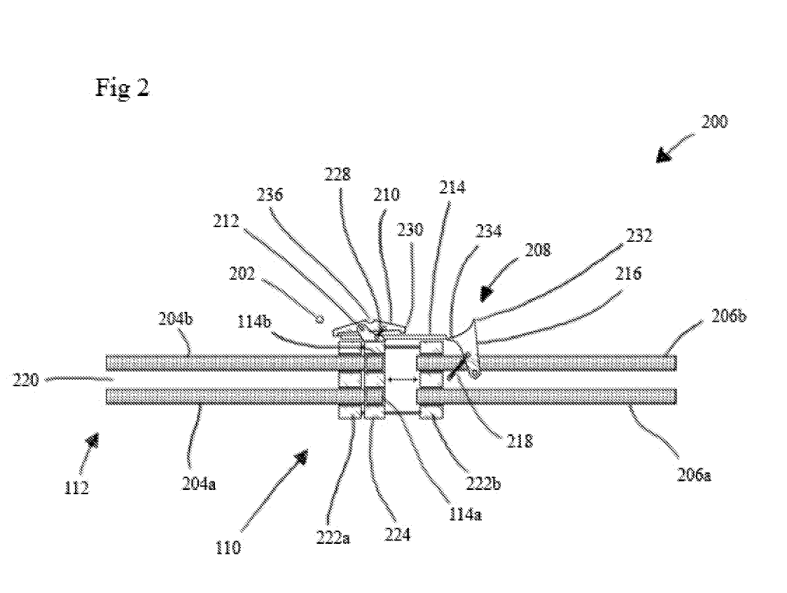

Accordingly, in one embodiment magnetic interaction between the at least one wheel magnet 106 and the stacked magnets 112 and the gate magnets 114 disposed on the at least one frame 108 is configurable to forcibly rotate the wheel 102. The wheel 102 rotation is harnassable to drive an axle disposed within the axle cavity 104 thereby extracting net-positive work from magnetic forces. In an additional embodiment, a plurality of the wheel 102 with at least one wheel magnet 106 are employed in coordination with a plurality of the at least one frame 108 with the stacked magnets 112 and the gate magnets 114 to multiply the magnetic interaction and increase rotational force. For instance, a plurality of wheels 102 can be aligned by their respective axle cavities 104 to drive a common axle. Further details on the magnetic interaction are set forth in FIGS. 2-6 infra.

FIG. 2 is a top plan view of a gate system for extracting net-positive work from magnetic forces, in accordance with an embodiment of the invention. In one embodiment, system 200 includes the stack magnets 112, the gate 110, and a latch assembly 208 each of which are mounted on the at least one frame 108 (FIG. 1). The stack magnets 112 include first stack magnets 204a and 204b and second stack magnets 206a and 206b. The gate 110 includes stationary gate housings 222a and 222b, a movable gate housing 224, and gate magnets 114a and 114b. The latch assembly 208 includes a latch arm 210, a runner 214, a lever 216, a lever spring 218, a latch arm spring 228, and a movable gate housing mount 226.

In one embodiment, the first stack magnets 204a and 204b are aligned approximately in parallel with one another to define a wheel magnet channel 220. The first stack magnets 204a and 204b are secured to the gate 110 on one end within the stationary gate housing 222a, which includes two surface recesses for receiving the first stack magnets 204a and 204b ends therein. Similarly, the second stack magnets 206a and 206b are aligned approximately in parallel with one another and are linearly aligned with, although physically separated from, the first stack magnets 204a and 204b to extend the wheel magnet channel 220. The second stack magnets 206a and 206b are secured to the gate 110 on one end within the stationary gate housing 222b, which also includes two surface recesses for receiving the second stack magnets 206a and 206b ends therein. The stationary gate housings 222a and 222b and are separated by a distance and secure the first stack magnets 204a and 204b and the second stack magnets 206a and 206b relative to the at least one frame 108 (FIG. 1). The movable gate housing 224 is slidably disposed within the gate 110 between the stationary gate housings 222a and 222b. The movable gate housing 224 includes two surface recesses for receiving the gate magnets 114a and 114b such that they extend across a width of the movable gate housing 224, are in parallel with one another to extend the wheel magnet channel 220, and are linearly aligned with, but separable from, the first stack magnets 204a and 204b and the second stack magnets 206a and 206b. The first stack magnets 204a and 204b, the gate magnets 114a and 114b, and the second stack magnets 206a and 206b have their respective magnetic poles commonly aligned such that the gate magnets 114a and 114b are similarly attracted to both the first stack magnets 204a and 204b and the second stack magnets 206a and 206b. Accordingly, the movable gate housing 224, including the gate magnets 114a and 114b disposed therein, is configurable to slidably transition between the stationary gate housing 222a and the stationary gate housing 222b to effectively extend and retract the first stack magnets 204a and 204b and the second stack magnets 206a and 206b.

The latch arm 210 of the latch assembly 208 is pivotably coupled to the movable gate housing 224 via the movable gate housing mount 226 at a pivot point 212. The latch arm 210 is configurable to slidably move along the runner 214 to facilitate movement of the movable gate housing 224 between the stationary gate housing 222a and the stationary gate housing 222b. However, the latch arm 210 is tension biased against one end of the runner 214 in such a manner to position the movable gate housing 224 against the stationary gate housing 222a. When force is applied to the latch arm 210 opposing the tension bias, the latch arm 210 moves along the runner 214 to position the movable gate housing 224 against the stationary gate housing 222b. With the movable gate housing 224 positioned against the stationary gate housing 222b, contraction force from the latch arm spring 228 pivots the latch arm 210 to position flange 230 over the runner 214 edge. The flange 230 grips the runner 214 edge thereby preventing the latch arm 210 from submitting to tension bias and retaining the movable gate housing 224 against the stationary gate housing 222b. The lever 216 is tension biased by the lever spring 218 such that lip 234 is disposed adjacent to the flange 230. Force applied to trigger 232 opposing the tension bias of the lever spring 218 is configurable to pivot the lever 216 thereby directing the lip 234 to displace the flange 230. Displacement of the flange 230 from the runner 214 end results in the latch arm 210 submitting to tension bias along the runner 214 and re-positioning the movable gate housing 224 against the stationary gate housing 222a.

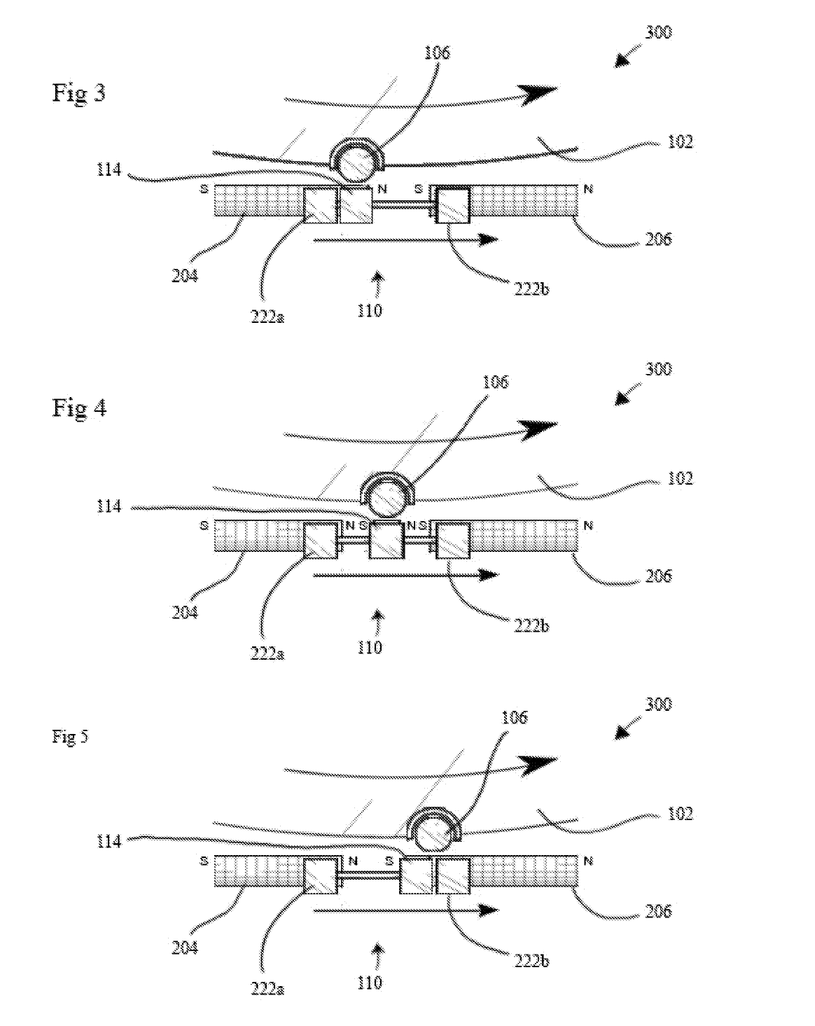

The wheel 102 perimeter is disposed proximate to the at least one frame 108 such that the at least one wheel magnet 106 is configurable to rotate along a plane defined by the wheel magnet channel 220 and across a length defined by the first stack magnets 204a and 204b, the movable gate housing 224, and the second stack magnets 206a and 206b (see in conjunction FIG. 1). A wheel pin 202 radially extends from the wheel 102 (not illustrated for clarity) and is configurable to physically interact with the latch assembly 208 as the wheel 102 rotates to facilitate transition of the movable gate housing 224 between the stationary gate housing 222a and the stationary gate housing 222b. As the wheel 102 rotates the wheel pin 202 arrives at the latch assembly to find the latch arm 210 tension biased against the runner 214 such that the movable gate housing 224 is positioned adjacent to the stationary gate housing 222a. The wheel pin 202 makes initial contact with the latch arm 210 when the wheel pin 202 removably mounts within a receiving notch 236. Force from the wheel pin 202 is transferred through the latch arm 210 to oppose its tension bias and displace the movable gate housing 224 along the runner 214 toward the stationary gate housing 222b. Upon reaching the runner 214 end, the latch arm 210 pivots on the pivot point 212 under tension from the latch arm spring 228 such that the flange 230 grips the runner 214 end and the movable gate housing 224 is retained against the stationary gate housing 222b. Pivot of the latch arm 210 also releases the wheel pin 202 from the receiving notch 236 and permits the wheel pin 202 to continue a path towards the lever 216. After a short distance, the wheel pin 202 makes contact with and exerts force against the lever 216 thereby pivoting the lever 216 against tension provided by the lever spring 218 and permitting the wheel pin 202 to travel along a surface of the lever 216 towards the trigger 232. Force from the wheel pin 202 against the trigger 232 results in the lip 234 displacing the flange 230 and permits the latch arm 210 to submit to tension bias and return along the runner 214 wherein the movable gate housing is positioned adjacent to the stationary gate housing 222a. Rotation of the wheel 102 returns the wheel pin 202 to the latch arm 210 where it again removably mounts to the receiving notch 236. Accordingly, the latch assembly 208 working in coordination with the wheel pin 202 provides a system whereby the movable gate housing 224 is slidably transitioned between the stationary gate housing 222a and the stationary gate housing 222b at a precise time. As will be discussed further in reference to FIGS. 3-5, the at least one wheel magnet 106 is configurable to move in coordination with the wheel pin 202 but within a plane defined by the wheel magnet channel 220 to magnetically interact with the first stack magnets 204a and 204b, the gate magnets 114a and 114b, and the second stack magnets 206a and 206b.

In alternative embodiments, the stack magnets 112 and the gate magnets 114 include additional magnets, fewer magnets, or alternatively arranged magnets. Further, the stack magnets 112 and the gate magnets 114 can include a permanent magnet, an electromagnet, a combination of a permanent magnet and an electromagnet, or some other magnet. In certain embodiments, the gate 110 is alternatively constructed or includes fewer or greater components. For instance, the gate 110 can be constructed from any material including plastic, metal, wood, or composite and can embody a different shape including having internal channels for receiving magnets. In yet a further embodiment, the latch assembly 208 includes fewer or greater components, is differently arranged or position, or is substituted or complimented with another system. Further, the latch system 208 and any of its components can be constructed from any material including plastic, wood, metal, or composite. For example, the latch assembly 208 can be positioned on any surface of the gate 110 including a top, bottom, or side surface. Also, the latch assembly 208 can be substituted with a magnetic pendulum system. One particular pendulum system includes a pendulum arm coupled to the movable gate housing 224 on one end and a magnet on its other end. The magnet is constantly repelled between two opposing magnets thereby swinging the pendulum arm about a fulcrum and moving the movable gate housing 224 back and forth between the stationary gate housing 222a and 222b.

FIG. 3 is an enlarged side elevational view of a wheel and gate system in a first position for extracting net-positive work from magnetic forces, in accordance with an embodiment of the invention. System 300 includes the wheel 102, the wheel magnet 106, the first stack magnet 204, the gate magnet 114, the second stack magnet 206, and the gate 110, which includes the stationary gate housing 222a, the movable gate housing 224, and the stationary gate housing 222b. The wheel 102 includes the wheel magnet 106 disposed on its perimeter and is configurable to rotate proximate and relative to the gate 110 such that the wheel magnet 106 is able to magnetically interact with the first stack magnet 204, the gate magnet 114, and the second stack magnet 206.

The magnetic poles of the first stack magnet 204, the gate magnet 114, the second stack magnet 206, and the wheel magnet 106 are labeled to assist in understanding the magnetic interactions; however, the magnetic poles can be reversed or changed as desired. In this embodiment, the first stack magnet 204 and the gate magnet 114 are magnetically coupled to one another introducing a common magnetic field with a south pole distal from the gate 110 and a north pole proximate to the gate 110. The wheel magnet 106 has its south pole facing outwardly from the wheel 102. As the wheel 102 rotates, the wheel magnet 106 angularly approaches the common magnetic field introduced from the first stack magnet 204 and the gate magnet 114 and the wheel magnet 106 is attracted towards the north pole at the gate magnet 114 end thereby exerting magnetic attractive force (F_{A}) upon the wheel magnet 106 and increasing its momentum. As the wheel magnet 106 approaches the gate magnet 114, the wheel pin 202 engages the latch assembly 208 (FIG. 2) to retain the wheel magnet 106 at a position approximately centered over the gate magnet 114.

FIG. 4 is an enlarged side elevational view of a wheel and gate system in a second position for extracting net-positive work from magnetic forces, in accordance with an embodiment of the invention. With the wheel magnet 106 retained under assistance from the latch assembly 208 (FIG. 2) at a position approximately centered over the gate magnet 114, momentum of the wheel magnet 106 opposes magnetic attractive force (F₁) between the gate magnet 114 and the first stack magnet 204 thereby separating the gate magnet 114 from the first stack magnet 204. This magnetic separation introduces a separate magnetic field surrounding the gate magnet 114 with a north pole facing the second stack magnet 206 and the south pole facing the first stack magnet 204. The wheel magnet 106 remains retained under assistance from the latch assembly 208 at a position approximately centered over the gate magnet 114 and momentum of the wheel magnet 106 displaces the gate magnet 114 toward the second stack magnet 206.

FIG. 5 is an enlarged side elevational view of a wheel and gate system in a third position for extracting net-positive work from magnetic forces, in accordance with an embodiment of the invention. The second stack magnet 206 has a magnetic field with its north pole being distal from the gate 110 and its south pole being proximate to the gate 110. With the wheel magnet 106 retained under assistance from the latch assembly 208 (FIG. 2) at a position approximately centered over the gate magnet 114, momentum from the wheel magnet 106 magnetically couples the gate magnet 114 to the second stack magnet 206 thereby releasing the wheel pin 202 from the latch assembly 208 (FIG. 2). Magnetic coupling of the gate magnet 114 and the second stack magnet 206 also introduces a common magnetic field surrounding the gate magnet 114 and the second stack magnet 206 with its south pole proximate to the gate 110 and its north pole distal from the gate 110. Thus, the wheel magnet 106 is suddenly positioned within a magnetic field of similar polarity thereby exerting a repulsive magnetic force (F_{R}) on the wheel magnet 106. Because the wheel pin 202 is released, the repulsive magnetic force on the wheel magnet 106 increases the momentum of the wheel 102 and results in the wheel magnet 106 distancing itself from the gate magnet 114. Rotation of the wheel 102 also results in the wheel pin 202 engaging the lever 216 thereby releasing the latch arm 210 (FIG. 2) to permit the gate magnet 114 to return to the first stack magnet 204 after an opposing force (F₂) is applied to separate the gate magnet 114 from the second stack magnet 206.

Further rotation of the wheel 102 permits the wheel magnet 106 to re-approach the common magnetic field provided by the first stack magnet 204 and the gate magnet 114. Accordingly, the system described herein results in a total force (F_{T}) being exerted upon the wheel magnet 106 and the wheel 102 that can be expressed as follows.

F_{T}=(F_{A}+F_{R})−(F₁+F₂)
where

F_{A}: magnetic attractive force exerted upon the wheel magnet 106

F_{R}: repulsive magnetic force exerted upon the wheel magnet 106

F₁: magnetic attractive force between the gate magnet 114 and the first stack magnet 204

F₂: magnetic attractive force between the gate magnet 114 and the second stack magnet 206

Therefore, when the sum of F₁ and F₂ is less than the sum of F_{A} and F_{R}, the total force F_{T} is positive thereby permitting net positive work to be extracted from magnetic forces.

In one particular embodiment, the wheel 102 is stationary and the first stack magnet 204, the gate magnet 114, and the second stack magnet 206 rotate about the wheel 102. Alternatively, the wheel 102 and the first stack magnet 204, the gate magnet 114, and the second stack magnet 206 rotate. In yet a further embodiment, the gate magnet 114 is held stationary while the first stack magnet 204 and the second stack magnet 206 slidably move relative to the gate magnet 114. In another embodiment, the wheel magnet 106, the first stack magnet 204, the gate magnet 114, and the second stack magnet 206 include a permanent magnet, an electromagnet, a combination of a permanent magnet and an electromagnet, or some other magnet. Additional or fewer magnets may be employed on the gate 110 or the wheel 102 and a plurality of system 300 can be employed on one or more of the wheel 102. It yet another embodiment, the wheel magnet 106 has a diameter that is shorter than the gate magnet 114 width. In alternative embodiments, the first stack magnet 204, the gate magnet 114, the second stack magnet 206, and the wheel magnet 106 can be different sizes, dimensions, or shapes.

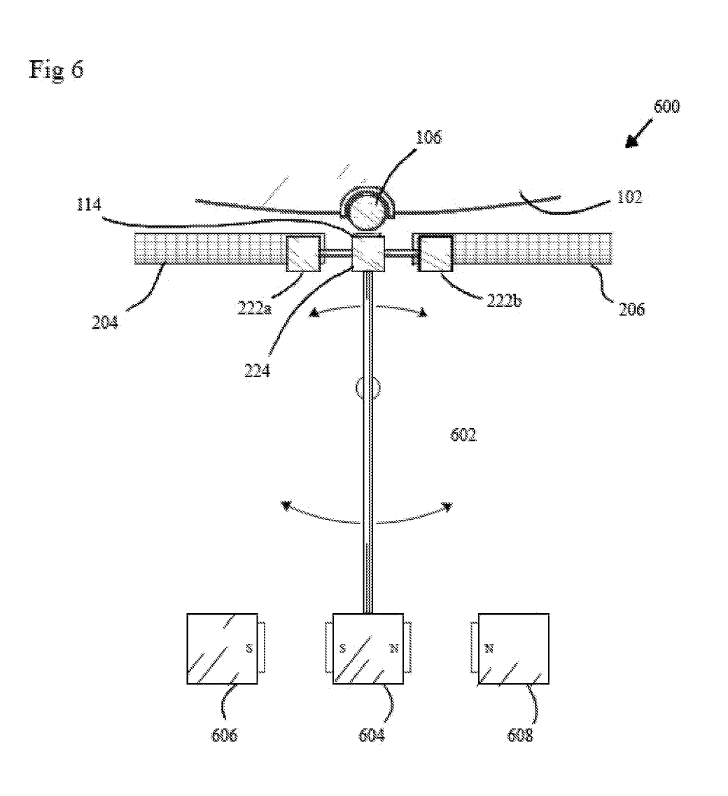

FIG. 6 is an enlarged side elevational view of a wheel, gate, and pendulum system for extracting net-positive work from magnetic forces, in accordance with an embodiment of the invention. In one embodiment, system 600 includes the wheel 102, the wheel magnet 106, the first stack magnet 204, the gate magnet 114, the second stack magnet 206, the stationary gate housing 222a, the movable gate housing 224, and the stationary gate housing 222b as discussed in references to FIGS. 3-5 supra. System 600 further includes a pendulum arm 602, a pendulum magnet 604, a first opposing magnet 606, and a second opposing magnet 608. In one embodiment, the pendulum arm 602 is coupled to the movable gate housing 224 on one end and the pendulum magnet 604 on another end. The pendulum magnet 604 is surrounded at a distance by the first opposing magnet 606 on one side and the second opposing magnet 608 on an opposite side. The first opposing magnet 606 and the second opposing magnet 608 are fastened to a support frame (not illustrated) to secure their respective positions relative to the pendulum magnet 604. The pendulum magnet 604 is configurable to oscillate between the first opposing magnet 606 and the second opposing magnet 608 about a fulcrum to transition the movable gate housing 224 between the stationary gate housing 222a and the stationary gate housing 222b.

Although the polarities can be reversed or different, the pendulum magnet 604 has a magnetic field with its south pole facing the first opposing magnet 606 and its north pole facing the second opposing magnet 608. The first opposing magnet 606 has a magnetic field with its south pole facing the pendulum magnet 604 and the second opposing magnet 608 has a magnetic field with its north pole facing the pendulum magnet 604. Thus, the pendulum magnet 604 is surrounded on either side by magnetic fields of similar polarity. Movement of the pendulum magnet 604 towards the first opposing magnet 606 drives the movable gate housing 224 against the stationary gate housing 222b and magnetically couples the gate magnet 114 to the second stack magnet 206. However, magnetic repulsive force exerted upon the pendulum magnet 604 from the first opposing magnet 606 (F₃) drives the pendulum magnet 604 from the first opposing magnet 606 and thereby separates the gate magnet 114 from the second stack magnet 206 and forces the pendulum magnet 604 towards the second opposing magnet 608. Movement of the pendulum magnet 604 towards the second opposing magnet 608 drives the movable gate housing 224 against the stationary gate housing 222a and magnetically couples the gate magnet 114 to the first stack magnet 204. However, magnetic repulsive force exerted upon the pendulum magnet 604 from the second opposing magnet 608 (F₄) drives the pendulum magnet 604 from the second opposing magnet 608 and thereby separates the gate magnet 114 from the first stack magnet 204 and forces the pendulum magnet 604 towards the first opposing magnet 608. Oscillation of the pendulum magnet 604 between the first opposing magnet 606 and the second opposing magnet 608 repeats indefinitely subject only to magnetic and structural fatigue thereby providing a mechanism for repeatedly transitioning the gate magnet 114 between the first stack magnet 204 and the second stack magnet 206. The latch assembly 208 is further usable to retain the movable gate housing 224 in a desired position against either the stationary gate housing 222a or the stationary gate housing 222b until the wheel magnet 106 is appropriately positioned relative to the gate magnet 114 (FIGS. 2-5). Thus, system 600 significantly offsets and effectively reduces the magnetic attractive force between the gate magnet 114 and the first stack magnet 204 (F₁) and the magnetic attractive force between the gate magnet 114 and the second stack magnet 206 (F₂). Accordingly, the system described herein results in a total force (F_{T}) being exerted upon the wheel magnet 102 that can be expressed as follows.

F_{T}=(F_{A}+F_{R})−((F₁−F₄)+(F₂−F₃))
which approaches

F_{T}=(F_{A}+F_{R})
where

F_{A}: magnetic attractive force exerted upon the wheel magnet 106

F_{R}: repulsive magnetic force exerted upon the wheel magnet 106

F₁: magnetic attractive force between the gate magnet 114 and the first stack magnet 204

F₂: magnetic attractive force between the gate magnet 114 and the second stack magnet 206

F₃: magnetic repulsive force exerted on the pendulum magnet 604 from the first opposing magnet 606

F₄: magnetic repulsive force exerted on the pendulum magnet 604 from the second opposing magnet 608

Therefore, because the sum of (F₁−F₄) and (F₂−F₃) is less than the sum of F_{A} and F_{R}, the total force F_{T} on the wheel magnet 106 is positive thereby rotating the wheel 102 indefinitely subject only to magnetic and structural fatigue and permitting net positive work to be extracted from magnetic forces. Rotation of the wheel 102 is usable to perform mechanical work or to generate electricity.

In other embodiments, the pendulum arm 602 is coupled to the stationary gate housing 222a or the stationary gate housing 222b. In another embodiment, additional or fewer of the pendulum arm 602, pendulum magnet 604, first opposing magnet 606, and second opposing magnet 608 are employed. The first opposing magnet 606, the pendulum magnet 604, or the second opposing magnet 608 can be permanent magnets, electromagnets, a combination of permanent and electromagnets, or some other magnet. In one particular embodiment, the pendulum system described herein is substituted with linearly arranged magnets or a spring based system.

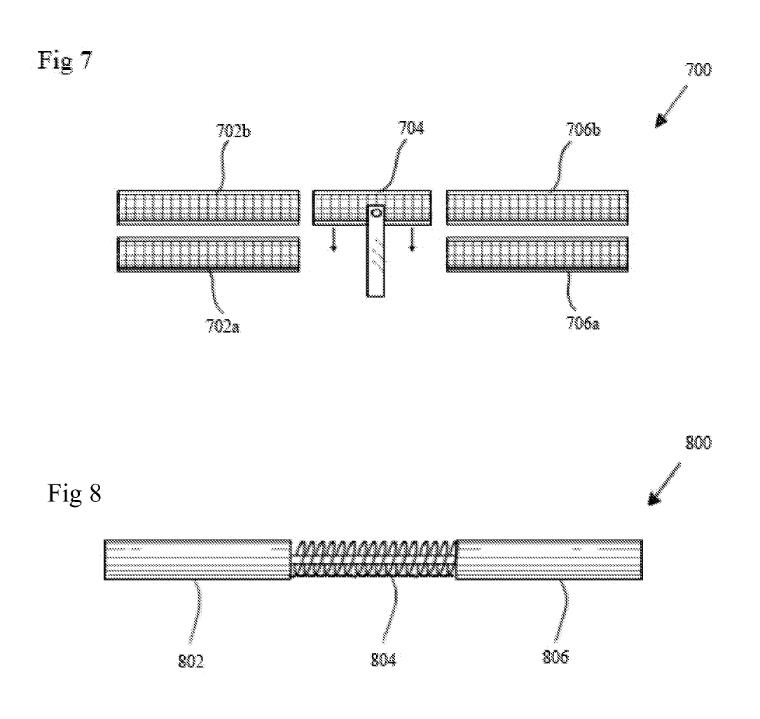

FIG. 7 is a top plan view of an alternative gate system for extracting net-positive work from magnetic forces, in accordance with an embodiment of the invention. System 700 can replace or compliment the gate system described in reference to FIG. 2. In one embodiment, system 700 includes a first stack magnet 702a, a first stack magnet 702b, a gate magnet 704, a second stack magnet 706a, and a second stack magnet 706b. The first stack magnet 702a is aligned with the second stack magnet 706a and is separated by a distance where the gate magnet 704 is movably disposed. Similarly, the first stack magnet 702b is aligned with the second stack magnet 706b and is separated by a distance where the gate magnet 704 is movably disposed. The first stack magnets 702a and 702b and the second stack magnets 706a and 706b are disposed adjacent to each other, respectively. The gate magnet 704 is configurable to alternatively bridge the first stack magnet 702a to the second stack magnet 706a or the first stack magnet 702b to the second stack magnet 706b.

Each of the first stack magnets 702a and 702b, the gate magnet 704, and the second stack magnets 706a and 706b have their magnetic poles commonly aligned (i.e. north poles pointing in a common direction). The gate magnet 704 begins by bridging the first stack magnet 702a to the second stack magnet 706a thereby creating an elongated magnet with a first common magnetic field. A first wheel magnet (not illustrated) approaches a first end of the first common magnetic field over the first stack magnet 702a and is initially repelled towards the gate magnet 704 where a Bloch Wall is established. As the first wheel magnet crosses over the gate magnet 704 and above the second stack magnet 706a, the gate magnet 704 slidably transitions to bridge the first stack magnet 702b to the second stack magnet 706b thereby introducing a separate magnetic field from the second stack magnet 706a. The first wheel magnet is repelled by the separate magnetic field from the second stack magnet 706a.

A second common magnetic field is introduced when the gate magnet 704 bridges the first stack magnet 702b to the second stack magnet 706b. A second wheel magnet (not illustrated) approaches a first end of the second common magnetic field over the first stack magnet 702b and is initially repelled towards the gate magnet 704 where a Bloch Wall is established. As the second wheel magnet crosses over the gate magnet 704 and above the second stack magnet 706b, the gate magnet 704 slidably transitions to bridge the first stack magnet 702a to the second stack magnet 706a thereby introducing a separate magnetic field from the second stack magnet 706b. The second wheel magnet is repelled by the separate magnetic field from the second stack magnet 706b. Force to drive the gate magnet 704 between the first stack magnet 702a and the second stack magnet 706a and the first stack magnet 702b and the second stack magnet 702b is provided by a pendulum system as described herein, a spring system, or some other system. The first and second wheel magnets can be coupled to a wheel to forcibly rotate the wheel for performing mechanical work or generating electricity.

In one particular embodiment, the second wheel magnet is omitted or complimented with additional wheel magnets. In yet another embodiment, the first stack magnet 702b and the second stack magnet 706b are omitted or complimented with additional stack magnets. In a further embodiment, the first stack magnets 702a and 702b, the gate magnet 704, the second stack magnet 706a and 706b, the first wheel magnet, the second wheel magnet, or the wheel are differently shaped, differently positioned, or are constructed from fewer of greater components. The first stack magnets 702a and 702b, the gate magnet 704, the second stack magnet 706a and 706b, the first wheel magnet, and the second wheel magnet can be permanent, electromagnets, a combination of permanent and electromagnets, or some other type of magnet.

FIG. 8 is a top plan view of an alternative electromagnet gate system for extracting net-positive work from magnetic forces, in accordance with an embodiment of the invention. System 800 can replace or compliment the gate system described in reference to FIG. 2. In one embodiment, system 800 includes a first stack magnet 802, an electromagnet 804, and a second stack magnet 806. The first stack magnet 802, the electromagnet 804, and the second stack magnet 806 are linearly aligned with the electromagnet 804 bridging the first stack magnet 802 to the second stack magnet 806.

The first stack magnet 802 and the second stack magnet 806 have their magnetic poles commonly aligned (i.e. north poles pointed in a common direction). To begin, current is removed from the electromagnet 804 and a wheel magnet (not illustrated) angularly approaches the first stack magnet 802 where it is forcibly attracted towards the first stack magnet 802 end proximate to the electromagnet 804. As the wheel magnet reaches the first stack magnet 802 end proximate to the electromagnet 804, current is applied to the electromagnet 804 resulting in a common magnetic field surrounding the first stack magnet 802, the electromagnet 804, and the second stack magnet 806. With current applied to the electromagnet 804, the wheel magnet is positioned near the common magnetic field bloch wall and permitted to effortlessly pass over the electromagnet 804 and approach the second stack magnet 806 under its own momentum. As the wheel magnet 804 reaches the second stack magnet 806 end proximate to the electromagnet 804, current is removed from the electromagnet 804 thereby terminating the common magnetic field and the wheel magnet is forcibly repelled from the second stack magnet 806 away from the electromagnet 804. A capacitor (not illustrated) is employable to conserve current for powering the electromagnet 804. The wheel magnet can be coupled to a wheel to forcibly rotate the wheel for performing mechanical work or generating electricity.

In an alternative embodiment, the electromagnet 804 is configurable to further removably establish a magnetic field having its magnetic poles reversely aligned with those of the first stack magnet 802 and the second stack magnet 806 thereby permitting increased options for interacting with the wheel magnet. In yet another embodiment, the first stack magnet 802, the electromagnet 804, and the second stack magnet 806 can be a permanent magnet, an electromagnet, a combination of a permanent magnet and electromagnet, or some other magnet. The first stack magnet 802, the electromagnet 804, and the second stack magnet 806 can be differently positioned and can include additional or fewer components. The wheel magnet can alternatively approach the first stack magnet 802, the electromagnet 804, and the second stack magnet 806 such as linearly.

While preferred and alternate embodiments of the invention have been illustrated and described, as noted above, many changes can be made without departing from the spirit and scope of the invention. Accordingly, the scope of the invention is not limited by the disclosure of these preferred and alternate embodiments. Instead, the invention should be determined entirely by reference to the claims that follow.

What is claimed is:

1. A system for extracting net-positive work from magnetic interactions, the system comprising:
a wheel, the wheel including at least one wheel magnet on the wheel perimeter;
a gate, the gate including a first stack magnet, a gate magnet, and a second stack magnet, the first stack magnet and the second stack magnet being separated, the gate magnet being slidably disposed between the first stack magnet and the second stack magnet, the gate magnet being magnetically attracted to the first stack magnet and the second stack magnet, the gate being disposed proximate to the wheel perimeter such that the at least one magnet is configurable to magnetically interact with the first stack magnet, the gate magnet, and the second stack magnet;
a pendulum arm, the pendulum arm defining a first end and a second end, the pendulum arm being coupled to the gate magnet on the first end and to a pendulum magnet on the second end, the pendulum arm configurable to drive the gate magnet between the first stack magnet and the second stack magnet upon oscillation; and
first and second opposing magnets, the first and second opposing magnets being disposed on opposing sides of the pendulum magnet, and the first and second opposing magnets being configurable to magnetically interact with the pendulum magnet to continuously oppose the pendulum magnet and oscillate the pendulum,
wherein the gate magnet is magnetically coupled with the first stack magnet upon rotational approach of the at least one wheel magnet to exert an attractive force upon the at least one wheel magnet, wherein momentum from the at least one wheel magnet facilitates separation of the gate magnet from the first stack magnet and magnetic coupling of the gate magnet to the second stack magnet, and wherein the magnetically coupled gate magnet and second stack magnet exert a repulsive force upon the at least one wheel magnet.

2. The system for extracting net-positive work from magnetic interactions of claim 1, the system further comprising:
a latch assembly, the latch assembly including a latch arm coupled to the gate magnet, the latch arm being slidably mounted on a runner, the runner extending between the first stack magnet on a first end and the second stack magnet on a second end, the latch arm being spring biased to the first end of the runner to magnetically couple the gate magnet to the first stack magnet; and
a wheel pin, the wheel pin radially extending from the wheel and configurable to removably engage the latch arm upon rotation of the wheel,
wherein the wheel pin engages the latch arm when the at least one wheel magnet is proximate to the gate magnet to facilitate separating the gate magnet from the first stack magnet and wherein the wheel pin disengages the latch arm when the gate magnet is magnetically coupled with the second stack magnet to permit continued rotation of the wheel.

3. The system for extracting net-positive work from magnetic interactions of claim 2, the system further comprising:
a first flange, the first flange being disposed on the latch arm to grip the first end of the runner to oppose force from the pendulum arm and retain the gate magnet against the first stack magnet until the wheel pin engages the latch arm; and
a second flange, the second flange being disposed on the latch arm to grip the second end of the runner to oppose force from the pendulum arm and retain the gate magnet against the second stack magnet until the wheel pin disengages the latch arm.

4. The system for extracting net-positive work from magnetic interactions of claim 3, the system further comprising:
an axle, the axle being coupled to a hub of the wheel and configurable to perform any of mechanical work and generate electricity upon rotation of the wheel.

5. The system for extracting net-positive work from magnetic interactions of claim 4, wherein the gate further includes another first stack magnet, another gate magnet, and another second stack magnet arranged in parallel with the first stack magnet, the gate magnet, and the second stack magnet to define a wheel magnet channel and wherein the at least one magnet is configurable to rotate in a common plane with the wheel magnet channel.

6. A system for extracting net-positive work from magnetic interactions, the system comprising:
a means for rotating at least one wheel magnet;
a means for slidably disposing a gate magnet between a first stack magnet and a second stack magnet to permit magnetic interaction with the at least one wheel magnet; and
a means for driving the gate magnet between the first stack magnet and the second stack magnet using magnetic force from at least one additional magnet,
wherein the gate magnet is magnetically coupled with the first stack magnet upon rotational approach of the at least one wheel magnet to exert an attractive force upon the at least one wheel magnet, wherein momentum from the at least one wheel magnet facilitates separation of the gate magnet from the first stack magnet and magnetic coupling of the gate magnet to the second stack magnet, and wherein the magnetically coupled gate magnet and second stack magnet exert a repulsive force upon the at least one wheel magnet.

7. The system for extracting net-positive work from magnetic interactions of claim 6, the system further comprising:
a means for positioning the gate magnet against the first stack magnet until the at least one wheel magnet is magnetically proximate to the gate magnet;
a means for moving the gate magnet to the second stack magnet in unison with the at least one wheel magnet; and
a means for returning the gate magnet to the first stack magnet when the at least one wheel magnet is magnetically distant from the gate magnet.

8. The system for extracting net-positive work from magnetic interactions of claim 7, the system further comprising:
a means for harnessing force applied to the at least one wheel magnet to perform any of mechanical work and generate electricity.

9. A method for extracting net-positive work from magnetic interactions, the method comprising the steps of:
magnetically coupling a first stack magnet to a gate magnet;
permitting at least one wheel magnet to approach the first stack magnet and the gate magnet, the first stack magnet and the gate magnet exerting magnetic attractive force upon the at least one wheel magnet;
facilitating separation of the gate magnet and the first stack magnet using magnetic force from at least one additional magnet;
facilitating movement of the gate magnet and the at least one wheel magnet towards a second stack magnet;
facilitating magnetic coupling of the gate magnet to the second stack magnet;
permitting the at least one wheel magnet to distance itself from the gate magnet and the second stack magnet, the gate magnet and the second stack magnet exerting magnetic repulsive force upon the at least one wheel magnet;
facilitating separation of the gate magnet and the second stack magnet using magnetic force from the at least one additional magnet;
facilitating movement of the gate magnet towards the first stack magnet; and
facilitating magnetic coupling of the gate magnet to the first stack magnet.

10. The method for extracting net-positive work from magnetic interactions of claim 9 wherein the facilitating separation of the gate magnet and the first stack magnet is accomplished when the at least one wheel magnet is proximate to the gate magnet.

11. The method for extracting net-positive work from magnetic interactions of claim 10 wherein the facilitating separation of the gate magnet and the second stack magnet is accomplished when the at least one wheel magnet has distanced itself from the gate magnet.

12. The method for extracting net-positive work from magnetic interactions of claim 11, the method further comprising the step of:
performing mechanical work from force exerted upon the at least one wheel magnet.

13. The method for extracting net-positive work from magnetic interactions of claim 12, the method further comprising the step of:
generating electricity from force exerted upon the at least one wheel magnet.
